(19) United States
(12) Patent Application Publication
(10) Pub. No.: US 2015/0325387 A1
(43) Pub. Date: Nov. 12, 2015

(54) ON-LOAD TAP CHANGER WITH CONNECTION TO OIL RESERVOIR OF A TRANSFORMER

(71) Applicant: MASCHINENFABRIK REINHAUSEN GMBH, Regensburg (DE)

(72) Inventors: Dieter DOHNAL, Lapersdorf (DE); Rainer FROTSCHER, Regenstauf (DE); Alfred BIERINGER, Geiselhoering (DE); Christian HURM, Regensburg (DE)

(21) Appl. No.: 14/652,649

(22) PCT Filed: Nov. 27, 2013
(86) PCT No.: PCT/EP2013/074878

§ 371 Date: Jun. 16, 2015

(30) Foreign Application Priority Data
Jan. 11, 2013 (DE) 10 2013 100 263.3

(51) Int. Cl. H01H 9/00; H01H 33/68

(52) U.S. Cl. CPC H01H 9/0005; H01H 33/68; H01H 2009/0022

(57) ABSTRACT

Disclosed is an on-load tap changer comprising a connection to an insulating liquid of a transformer. The on-load tap changer in a housing (9) and the transformer are in the transformer tank (7) and are surrounded by insulating liquid (6). At least one opening (10) is formed in the housing base (9B) and/or housing cover (9M), said opening providing a fluidic connection between the insulating liquid in the transformer tank and the insulating liquid in the housing.

The invention relates to an on-load tap changer with a connection to the oil reservoir of a transformer.

A power transformer with a tap changer is disclosed in German Patent Specification DE 10 2008 027 274 [US 2011/063064]. The power transformer and the tap changer are oil-filled. The tap changer is arranged in the transformer tank of the power transformer. The tap changer has a connecting flange that leads by way of a pipe line into the interior of the transformer tank of the power transformer so that the oil reservoirs of tap changer and power transformer are in connection with one another. An oil flow relay is arranged in the pipe line. Merely the connecting flange of the transformer tank leads to a single and common oil expansion is vessel.

German Patent Specification DE 619 635 discloses that the oil chamber of the transformer and the oil chamber of the changer are separated by a partition wall having filter-like passages. It is thus possible for equalization of the oil pressure between the two chambers to be produced.

German Utility Model Specification DE 20 2010 011 524 [US 2013/0213777) shows a tap chamber for uninterrupted switching over between winding taps of a tapped transformer. The tapped transformer is arranged in a transformer tank filled with insulating oil. The tap changer does not have an individual housing or a housing completely surrounding it, so that the tap changer is arranged within the transformer tank or directly externally at the transformer tank and in each instance in connection with the oil filling thereof.

An on-load tap changer serves for uninterrupted switching over between different winding taps of a regulating winding of a tapped transformer. For this purpose, as disclosed in German Utility Model Specification DE 20 2010 011 521 [US 2013/0206555], at least one selector for power-free selection of the respective winding tap that is to be switched over to, of the tapped transformer and a load changeover switch for the actual switching over from the connected to the new, preselected winding tap are provided. The at least one selector and the load changeover switch are arranged physically separately from one another in the transformer tank.

Chinese Utility Model CN 201063285 Y discloses a cage-like construction for an insert of an on-load tap changer. The rod construction is immersed in an oil tank in which the transformer windings are fastened.

Various forms of embodiment of a tap changer are disclosed in the International Patent Applications WO 2007/003537 [U.S. Pat. No. 7,923,329], WO 2007/003539 [U.S. Pat. No. 7,731,415], WO 2007/009960 U.S. Pat. No. 7,902,951] and WO 2007/009961 [also U.S. Pat. No. 7,901,951]. The tap changers each have an equalization reservoir.

The object of the present invention consists in designing an on-load tap changer in such a way that a more economic and simpler construction of a system of on-load tap changer and transformer is possible, in which case an economic and simple capability of re-equipping existing systems shall also be possible.

The above object is fulfilled by an on-load tap changer according to the features of claim 1.

The on-load tap changer according to the invention has a connection to an insulating liquid of a transformer. The transformer and the insulating liquid are surrounded by a transformer tank, wherein the on-load tap changer is mounted in a housing consisting of a housing cover, a housing base and a housing jacket. The housing itself is filled with insulating liquid and projects into the transformer tank. The insulating liquid surrounds the on-load tap changer. According to the invention at least one opening is formed in the housing base and/or housing jacket, which opening provides a fluid connection between the insulating liquid in the transformer vessel and the insulating liquid in the housing.

According to one form of embodiment of the invention at least one opening is formed in the housing base. The opening can be formed by a drain screw being removed from the housing base.

Another possibility would be designing the at least one opening in the housing jacket or in the housing base in such a way that it can be opened or closed by access from outside. This has the advantage that, for maintenance, the housing cover of the on-load tap changer can simply be opened without insulating liquid running out. A movable closure element can close or open the at least one opening 10 in the housing base 9B and/or housing jacket 9M by means of an actuating element that acts via the housing cover of the on-load tap changer.

Further advantages and advantageous embodiments of the invention are the subject of the following figures as well as the parts of description thereof, wherein in detail:

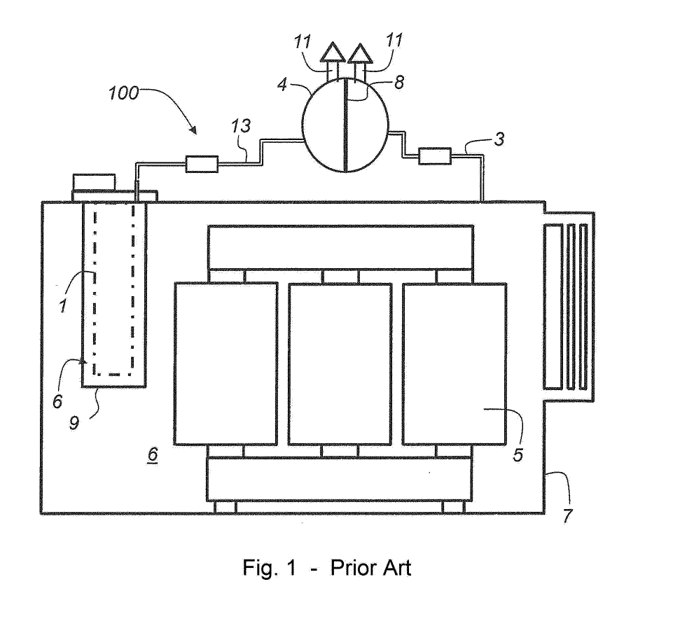

FIG. 1 shows a schematic view of a system consisting of on-load tap changer and transformer according to the prior art;

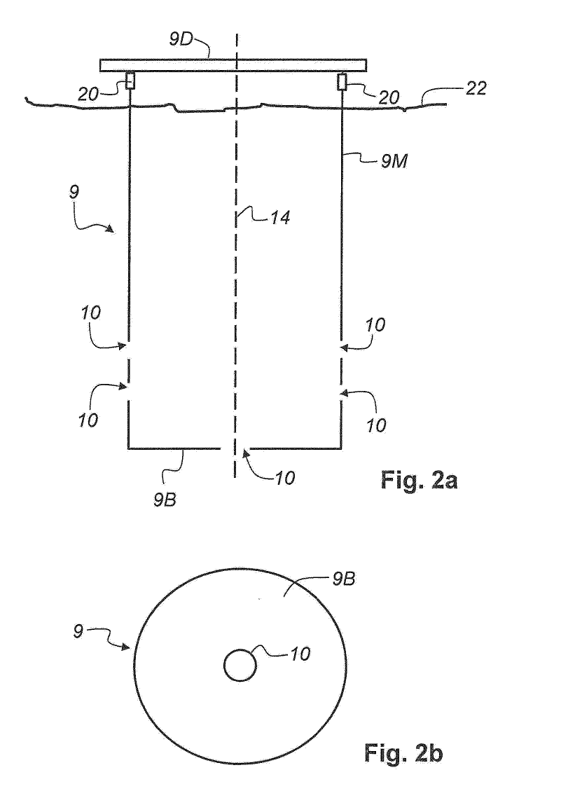

FIG. 2a shows a schematic illustration of the housing for the on-load tap changer in section along the longitudinal axis;

FIG. 2b shows a base view of the housing for the on-load tap changer;

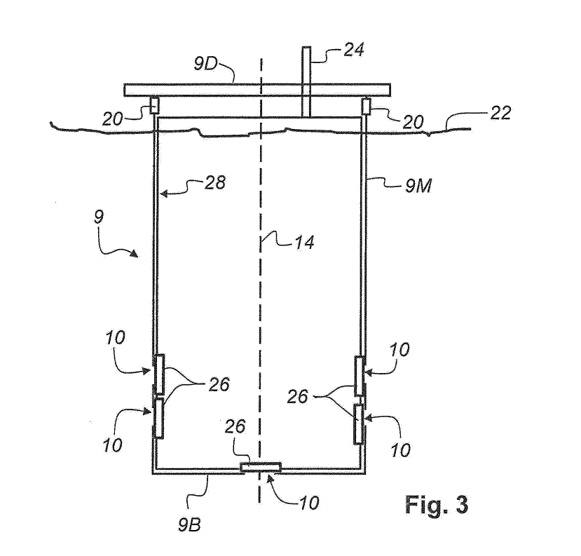

FIG. 3 shows a side view of the housing of the on-load tap changer in accordance with the invention according to a further form of embodiment;

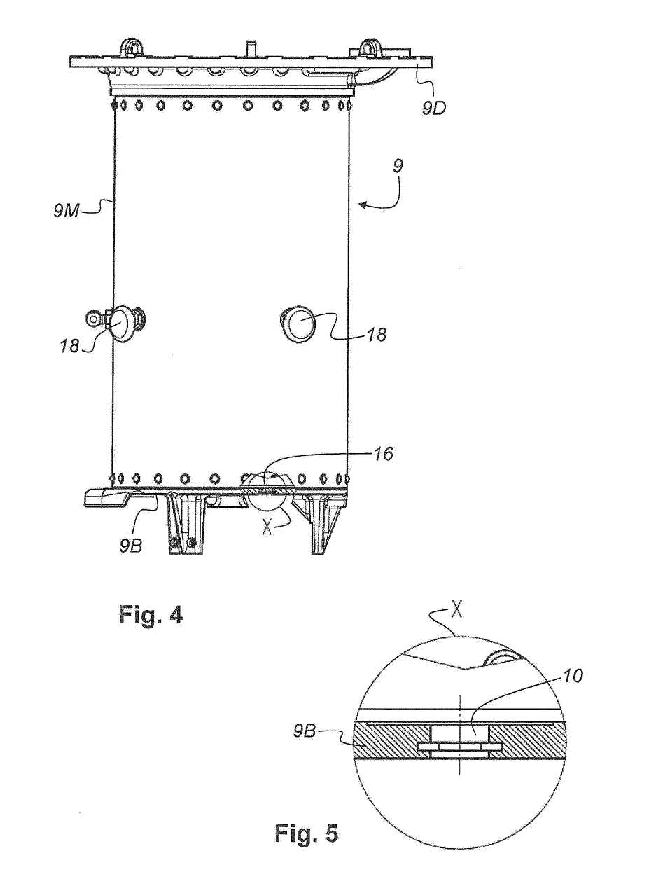

FIG. 4 shows a side view of the housing of the on-load tap changer in accordance with the invention according to a further form of embodiment;

FIG. 5 shows an illustration, to enlarged scale, of the region characterized in FIG. 4 by X; and

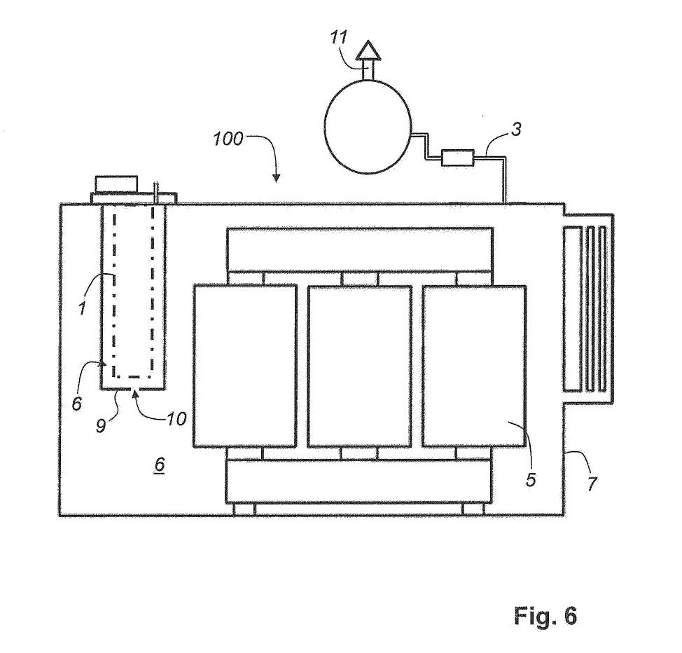

FIG. 6 shows a schematic view of a system consisting of on-load tap changer according to the invention and transformer.

Identical reference numerals are used for the same or equivalent elements of the invention. The illustrated embodiment represents merely one possibility of how an on-load tap changer can be furnished with a connection to the insulating liquid of a transformer.

As can be seen from the illustration of a system 100 of the prior art according to FIG. 1, the on-load tap changer 1 is inserted into the transformer tank 7 of the transformer 5. The transformer tank 7 receives an insulating liquid 6 that is preferably an insulating oil. The transformer 5 is completely surrounded by the insulating liquid 6. The on-load tap changer 5 itself is surrounded by a cylindrical housing 9. An insulating liquid 6 is similarly in the housing 9, so that the components (electrical and mechanical) are surrounded by the insulating liquid 6. The insulating liquid 6 of the on-load tap changer 1 and the insulating liquid 6 of the transformer 5 are physically separated from one another by the housing 9 of the on-load tap changer 1. Intermixing does not take place.

The transformer tank 7 is connected by way of a line 3 with an equalizing vessel 4. Equally, the housing 9 of the on-load tap changer 1 is connected by way of line 13 with the equalizing vessel 4. In the case of heating of the insulating liquid 6 thermal expansion occurs and thus an increase in the reservoir that is absorbed by the equalizing vessel 4. Provided in the equalizing vessel 4 is a partition wall 8 that hermetically separates the insulating liquid 6 in the housing 9 of the on-load tap changer 1 from the insulating liquid 6 in the transformer tank 7. The equalizing vessel 4 is connected on each of the two sides of the partition wall 8 by way of a dry seal 11 with the ambient air so that no pressure fluctuations arise in the case of changes in reservoir in the transformer tank 7.

FIG. 2a and FIG. 2b show different views of the housing 9 of the on-load tap changer 1, wherein the on-load tap changer 1 for the sake of clarity is not arranged in the housing 9. A schematic illustration of the housing 9 for the on-load tap changer 1 in section along the longitudinal axis 14 of the housing 9 can be seen in FIG. 2a. The housing 9 consists of a housing cover 9D, a housing base 9B and a housing jacket 9M. As can be seen from FIG. 1, the housing 9 projects into the transformer tank 7. In the form of embodiment illustrated in FIGS. 2a and 2b at least one opening 10 is formed in the housing base 9B and in the housing jacket 9M. The number and shape of the illustrated openings 10 are not to be interpreted as restricting the invention. A fluid connection between the insulating liquid 6 and the transformer tank 9 and the insulating liquid 6 in the housing 9 is provided by way of the openings 10. Thus, the insulating liquid 6 in the transformer tank 7 and the insulating liquid 6 in the housing 9 are disposed at the same pressure level. The base view that is illustrated in FIG. 2b, of the housing 9 for the on-load tap changer shows the form of embodiment in which an opening is formed in the housing base 9B of the housing 9. If gases form in the interior of the housing 9 for the on-load tap changer 1 these can be conducted into the transformer tank 7 by way of filters 20 that can be constructed as sintered bronze filters. The filters 20 are mounted in the housing 9 of the on-load tap changer 1 in such a way that they are disposed above the level 22 of the insulating liquid 6.

The situation is illustrated in FIG. 3 that each opening 10 can be closed or opened by a respective movable closure element 26 per opening 10 by means of an actuating element 24 guided through the housing cover 9D of the on-load tap changer 1. As already mentioned, the at least one opening 10 can be provided in the housing base 9B and/or housing jacket 9M. The closure elements 26 are, in the form of embodiment illustrated here, mounted on a support construction 28. The actuating element 24 rotates the support construction 28 in suitable manner so that the at least one opening 10 is closed or opened. The mechanism that is illustrated in the present description, for closing or opening the at least one opening 10 shall not be interpreted as restricting the invention. Different possibilities by which the openings 10 in the housing 9 of an on-load tap changer 1 are closed are conceivable to an expert.

FIG. 4 shows a side view of the housing 9 of the on-load tap changer 1 according to the invention in accordance with a further form of embodiment of the invention. A detachable drain screw 16 is provided in the housing base 9B. Lead-throughs 18 by way of which electrical lines (not illustrated) are led to the on-load tap changer 1 are installed in the housing jacket 9M.

An illustration of the region characterized in FIG. 4 by X is illustrated to enlarged scale in FIG. 5, wherein the drain screw 16 is removed from the housing base 9B of the housing 9 so that the opening 10 is formed. The fluid connection between the insulating liquid 6 in the transformer tank 7 and the insulating liquid 6 in the housing 9 is provided by way of the opening 10.

A schematic view of the system 100 consisting of on-load tap changer 1 according to the invention and transformer 5 is illustrated in FIG. 6. Due to the fact that the opening 10 provides the fluid connection between the insulating liquid 6 in the transformer tank 7 and the insulating liquid 6 in the housing 9 of the on-load tap changer 1 use can be made of a single and common equalizing vessel 4. The design in accordance with the invention of the housing 9 of the on-load tap changer 1 thus enables a simpler and more economic construction of the system 100, since at least the line 13 from the power transformer 1 to the equalizing vessel 4 can be omitted. In addition, the single equalizing vessel 4 is here provided with a dry seal 11 connected with the ambient air so that no fluctuations in pressure arise in the case of changes in reservoir in the transformer tank 7.

Reference numeral list:

| | |
|---|---|
| 1 on-load tap changer | 11 dry seal |
| 3 line | 13 line |
| 4 equalizing vessel | 14 longitudinal axis |
| 5 transformer | 16 drain screw |
| 6 insulating liquid | 18 lead-throughs |
| 7 transformer tank | 20 filter |
| 8 partition wall | 22 level of the insulating |
| 9 housing | liquid |
| 9B housing base | 24 actuating element |
| 9D housing cover | 26 movable closure element |
| 9M housing jacket | 28 support construction |
| 10 opening | 100 system |

1. An on-load tap changer with a connection to an insulating liquid of a transformer, wherein the transformer and the insulating liquid are surrounded by a transformer tank, and the on-load tap changer is mounted in a housing consisting of a housing cover, a housing base and a housing shell, which housing projects into the transformer tank and is filled with the insulating liquid that also surrounds the on-load tap changer, the housing base and/or the housing shell being formed with at least one hole that forms a fluid connection between the insulating liquid in the transformer tank and the insulating liquid in the housing.

2. The on-load tap changer according to claim 1, wherein the at least one opening is formed in the housing base.

3. The on-load tap changer according to claim 2, wherein a single opening is formed in the housing base by a removed drain screw.

4. The on-load tap changer according to claim 1, further comprising:
a respective movable closure element that closes or opens the at least one opening in the housing base and/or housing shell by an actuating element via the housing cover.
